(19) United States
(12) Patent Application Publication
(10) Pub. No.: US 2008/0098163 A1
(43) Pub. Date: Apr. 24, 2008

(54) METHOD FOR READING AND WRITING DATA IN A FLASH MEMORY IN AN EMBEDDED SYSTEM

(76) Inventor: Chun-Fu Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/874,205

(22) Filed: Oct. 18, 2007

(30) Foreign Application Priority Data
Oct. 19, 2006 (TW) 095138611

(51) Int. Cl. G06F 12/00

(52) U.S. Cl. 711/103; 711/E12.001

(57) ABSTRACT

By utilizing a cache memory's high-speed data access feature of a processor in an embedded system, when a data reading action and a data writing/erasing action occur in a same partition (read while write/erase, RWW/E in the same partition) of a NOR flash memory, the processor intentionally generates an instruction cache miss in the cache memory, and the processor loads the data to be read into the cache memory. The data loaded into the cache memory is read and the data in the partition to be written/erased is written/erased at the same time.

### BACKGROUND OF THE INVENTION

1. Field of the Invention

The present invention relates to a method for reading and writing data in a flash memory, and more specifically, to a method for concurrently reading and writing data in a same partition of a flash memory of an embedded system.

2. Description of the Prior Art

NOR flash memory is a memory structure that can perform reading and writing in a block. NOR flash memory has been widely applied in embedded systems in recent years, especially in mobile devices such as mobile phones. Other than storing data, the NOR flash memory is also featured in its random accessibility and thereby allows the system to execute a program code on itself.

On the other hand, the NOR flash memory is also enhanced with the ability to read while write/erase (RWW/E) to fulfill the more critical multimedia requirement on a mobile device. A specific management strategy about manipulating the data in the NOR flash memory is carried out by partitioning and banking the data. When the system reads data in a partition of the NOR flash memory, data in other partitions of the NOR flash memory can be written or erased at the same time. Please refer to FIG. 1. FIG. 1 is an illustration of data management of a NOR flash memory 10 according to a prior art. The memory 10 is divided into a plurality of partitions 22 in a logical layer 20 where the size of each partition 22 can be 512 KB, 1 MB, or 2 MB, and each partition 22 comprises a plurality of blocks 32. In fact, the plurality of blocks 32 is defined in a physical layer 30. Such dual operation mode like RWW/E immensely improves the efficiency of the mobile device that has more and more powerful functions.

There is, however, a hardware restriction on implementing the powerful feature of RWW/E: it is not allowed to perform writing or erasion in a partition at the same time when the system is reading from the same partition. This is because the flash memory can only deal with high-level instructions, such as reading, writing, and erasing, on the basis of bus cycle unit rather than instruction unit. For example, if it takes two bus cycles to perform an erasing instruction and only one bus cycle for a reading instruction, it is very likely that the bus cycle for the reading instruction comes between the two bus cycles for the erasing instruction if the system performs reading and erasion in the same partition at the same time, which leads to an address mistake when accessing the partition and the system gets a device failure of the flash memory.

### SUMMARY OF THE INVENTION

The claimed invention provides a method for reading and writing data in a flash memory in an embedded system, which comprises a flash memory and a cache memory, and the flash memory comprises a plurality of partitions each having a plurality of blocks. The method comprises detecting a block to be modified in the flash memory; loading a program code for modifying the block from the flash memory to the cache memory according to a specific condition; and modifying the block according to the program code loaded in the cache memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of data management of a NOR flash memory according to a prior art.

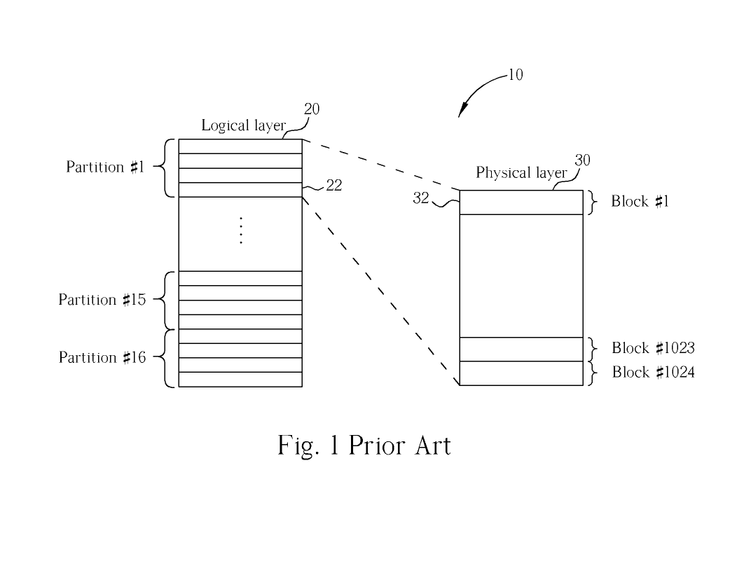

FIG. 2 is a flow chart of a method for reading and writing data in a flash memory according to the present invention.

FIG. 3 is an illustration of an exemplary embodiment according the present invention.

FIG. 4 is an illustration of an exemplary embodiment of a program code for generating an instruction cache miss according to the present invention.

### DETAILED DESCRIPTION

Generally, a built-in processor of an embedded system is equipped with an instruction cache memory, which the size varies in different products. The present invention utilizes the high-speed data access feature of the instruction cache memory to realize the ability of reading and erasing (or writing) data in the same partition at the same time.

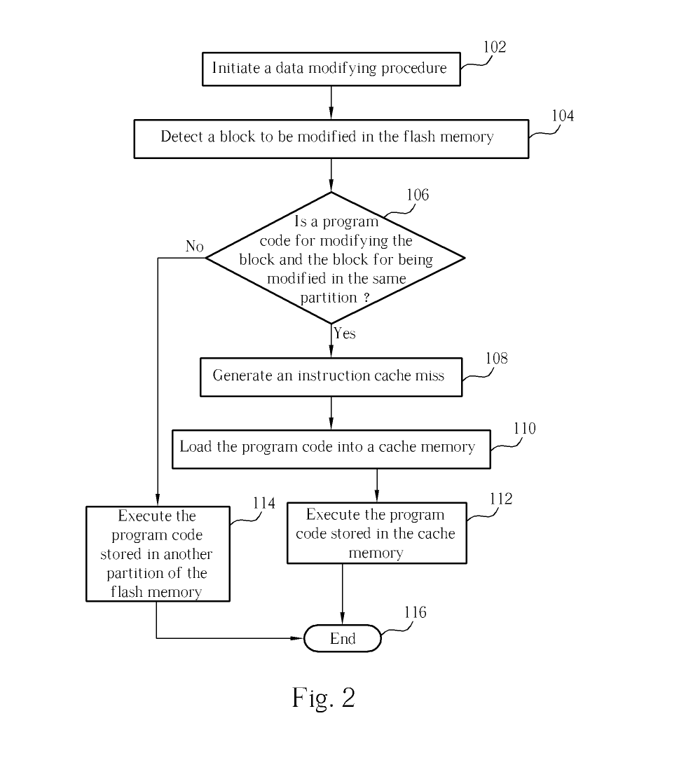

Please refer to FIG. 2. FIG. 2 is a flow chart of a method for reading and writing data in a flash memory according to the present invention. The method comprises the following steps:

Step 102: Initiate a data modifying procedure in an embedded system;

Step 104: Detect a block to be modified in a flash memory of the embedded system;

Step 106: Detect if a program code for modifying the block and the block to be modified are in the same partition of the flash memory; if the program code and the block are not in the same partition, go to Step 114;

Step 108: Generate an instruction cache miss in a cache memory of a processor;

Step 110: Load the program code into the cache memory when the processor of the embedded system detects the instruction cache miss;

Step 112: Execute the program code loaded in the cache memory for modifying the content of the block to be modified; go to Step S116;

Step 114: Execute the program code stored in another partition of the flash memory for modifying the content of the block;

Step 116: End.

To modify the content of the block in the flash memory mentioned in the steps means to write data into the block or to erase the content of the block.

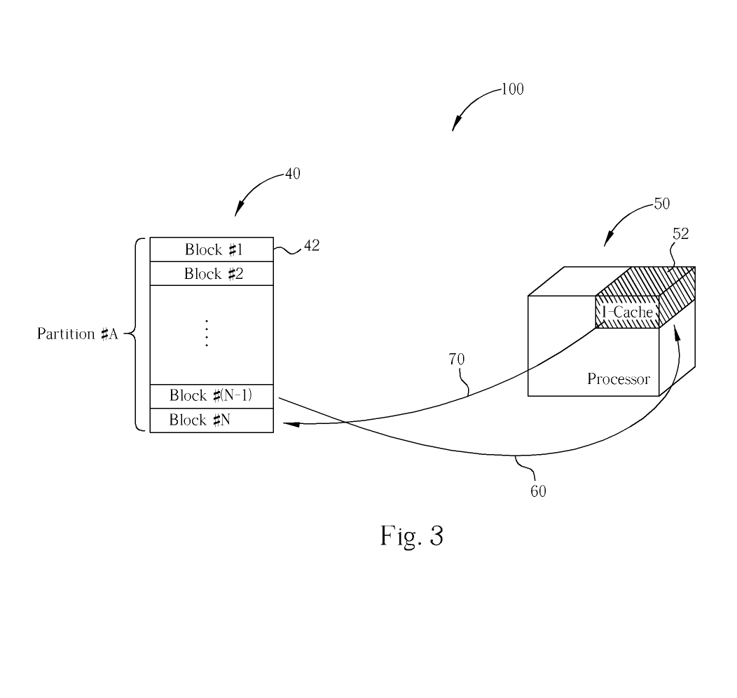

Please refer to FIG. 3. FIG. 3 is an illustration of an exemplary embodiment of the method for reading and writing data in the same partition of a flash memory 40 in an embedded system 100 according to the present invention. The flash memory 40 of the embedded system 100 comprises a plurality of blocks 42, which is the plurality of blocks 42 in the same partition #A in FIG. 3. The embedded system 100 also comprises a processor 50 having a cache memory 52 inside. The flash memory 40 is for storing program codes of an operating system and of the peripheral drivers of the embedded system 100. When the processor 50 receives a command to erase data of a block #N, which belongs to partition #A, an error named RWW/E hardware restriction occurs if the program code for performing the erasion of the block #N locates in block #(N−1) that just belongs to the same partition #A.

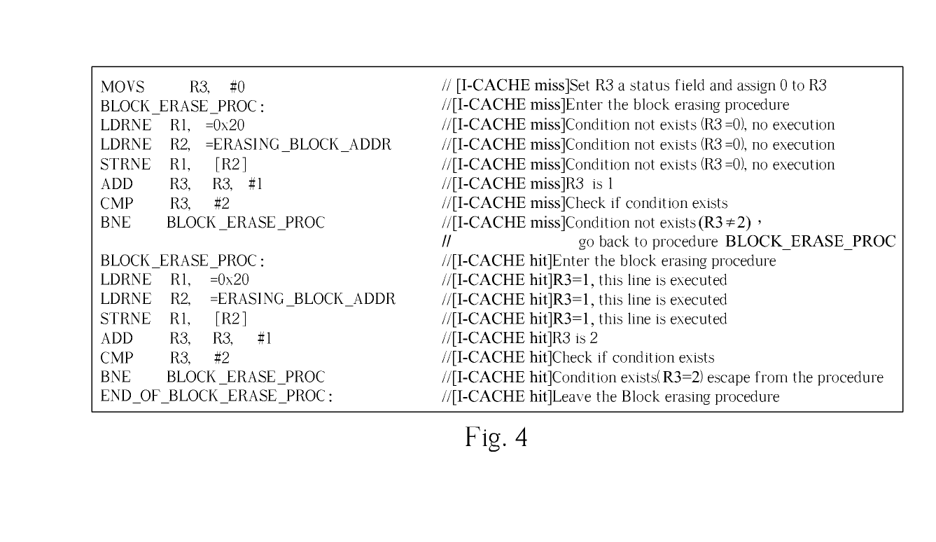

In this case, the embedded system 100 moves the program code for performing the erasion of block #N into the cache memory 52 using a software program and executes the program code in the cache memory 52. Due to the fact that the cache memory 52 of the processor 50 is a hardware level memory, which can not be directly modified by a software program, Step 108 in FIG. 2 notes that an instruction cache miss is generated first and Step 110 in FIG. 2 notes that the processor 50 will automatically load the program code for performing the erasion from block #(N−1) to the cache memory 52. An exemplary embodiment of the procedure for generating the instruction cache miss is shown in FIG. 4.

Unlike the flash memory 40, the cache memory 52 of the processor 50 has an extremely fast speed to access data. Therefore, it takes much shorter time to load the program code from block #(N−1) to the cache memory 52 compared to the time it takes to access data in the flash memory 40. And after the program code is loaded into the cache memory 52, it is executed directly in the cache memory 52 to erase the data of block #N in partition #A, avoiding possible occurrence of bus cycle conflict caused by the action of executing the program code directly in block #(N−1). Moreover, from a system perspective, reading program code in block #(N−1) and erasing data in block #N can be regarded as concurrent operations, realizing the hardware feature, RWW/E in the flash memory 40 that effectively solve the problem of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reading and writing data in a flash memory in an embedded system, the embedded system comprising a flash memory and a cache memory wherein the flash memory comprises a plurality of partitions, each having a plurality of blocks, the method comprising:
detecting a block to be modified in the flash memory;
loading a program code for modifying the block from the flash memory to the cache memory according to a specific condition; and
modifying the block according to the program code loaded in the cache memory.

2. The method of claim 1 wherein the specific condition comprises detecting whether the program code and the block to be modified are in the same partition.

3. The method of claim 2 wherein loading a program code for modifying the block from the flash memory to the cache memory is loading the program code to the cache memory of a processor when the program code and the block to be modified are in the same partition.

4. The method of claim 1, the cache memory being installed in a processor of the embedded system, wherein loading a program code for modifying the block from the flash memory to the cache memory comprises:
generating an instruction cache miss in the cache memory; and
loading the program code to the cache memory when a processor detects the cache miss.

5. The method of claim 1 wherein modifying the block is writing data into the block.

6. The method of claim 1 wherein modifying the block is erasing the content of the block.
